(19) United States
(12) Patent Application Publication
(10) Pub. No.: US 2008/0218590 A1
(43) Pub. Date: Sep. 11, 2008

(54) METHOD AND SYSTEM FOR MULTIPLE-CODEC SURVEILLANCE VIDEO STORAGE AND RETRIEVAL

(76) Inventors: Sang Jun Park, Bupyeong-gu (KR); Yoon Jin Kim, Gwanak-gu (KR); Sung Rae Kim, Suwon-si (KR)

Correspondence Address: STETINA BRUNDA GARRED & BRUCKER, 75 ENTERPRISE, SUITE 250, ALISO VIEJO, CA, 92656, US

(21) Appl. No.: 11/683,960

(22) Filed: Mar. 8, 2007

(51) Int. Cl. H04N 7/18

(52) U.S. Cl. 348/143; 348/E07.086

(57) ABSTRACT

A method and system for processing surveillance video stored on a video storage system is provided. A universal media control command is received and translated to a local control command specific to a video storage system. The surveillance video is retrieved in response to receipt of the local control command. The surveillance video can be decoded into raw video data and displayed, or be encapsulated within a universal data file. The surveillance video may be subsequently extracted from the universal data file

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND OF THE INVENTION

1. Technical Field

The present invention relates generally to video surveillance devices. More particularly, the present invention relates to methods and systems for multiple-codec surveillance video storage and retrieval.

2. Related Art

As an integral part of a broad security plan, surveillance systems are utilized for crime prevention, detection, and prosecution purposes. Common locations where surveillance systems are utilized include banks, airports, casinos, parking lots and garages, corporate facilities and the like, though increased technological availability has brought about its deployment in more private settings such as personal residences. Surveillance systems typically employ closed circuit television (CCTV) cameras that are connected to a central observation station with one or more video monitors. Thus, multiple locations may be monitored simultaneously from a single location by a minimal number of operators. It is generally regarded that the known presence of surveillance cameras decreases the incidence of crime, and vigilant monitoring increases the likelihood of early detection and intervention by the police or privately retained security guards.

Earlier analog CCTV cameras acquire surveillance video in the same format as broadcast television. This is understood to be an analog signal of 30 frames per second, with each frame containing 480 lines and each line containing 640 resolvable elements. As briefly mentioned above, another function of surveillance systems is the preservation of footage for apprehending and prosecuting criminals. In the event of a problem or security incident, the resulting recording can be examined and/or presented as proof. For these purposes, prior analog CCTV cameras may also be connected to video tape recorders that record the aforementioned analog signals in addition to video monitors. Ordinary videotapes, which record video footage at thirty frames per second, typically have the capacity to record three hours of video. The fast frame rate often results in the storage of redundant images, however. In order to record for an extended period of time, such redundant images are not recorded by running the tape recorders at an extremely slow speed, or setting the tape recorder to run on a time lapse mode, e.g., storing a captured image every four seconds or so. Alternatively, the tape recorder may be triggered by a motion detection sensor, so that the video recorder does not record anything except when there is motion in the observed area. This also reduces the consumption of tape, and finding footage of interest becomes easier.

Conventional analog tape recorders, however, have a number of deficiencies. The machinery is mechanically complex and subject to frequent failure, and maintenance such as cleaning of the video heads is often necessary to ensure that video footage is properly recorded. Operation and maintenance of tape recorders represents a considerable cost and workload overhead, as most security systems are operated continuously for the life of the installation. Another deficiency is that the video footage is in analog form throughout its use, from acquisition, to storage on magnetic tape, to being displayed on a video monitor. Thus, the recorded surveillance video is subject to degradation from long-term storage, stray magnetic fields, and introduction of noise from repeated use of the magnetic tape. Analog signals cannot be compressed by removing the correlation between adjacent pixels of the same image, or pixels at the same location in sequential images. Such inefficient representation increases the need for large storage capacities. Further, processing of analog video signals is limited to such simple enhancements as adjustment of brightness and contrast, and sophisticated image enhancements cannot be applied. The playback of analog video is likewise limited only a few simple techniques, such as normal play, pause, fast forward and reverse, and advanced playback functions such as zooming are unavailable.

Digital video largely overcomes the aforementioned deficiencies in analog surveillance systems. There is no degradation of the video signal, and the surveillance footage may be repeatedly copied, accessed, and enhanced non-destructively. Furthermore, the capacity of the storage devices exceeds that of conventional videocassettes and the number of recordable hours is further increased with various video compression techniques. The reliability of digital storage devices such as hard disk drives and optical media (CD, DVD, etc.) drives are also superior to videocassette tapes and its associated playback mechanisms.

Earlier digital video surveillance systems utilize existing analog CCTV cameras in conjunction with digital storage devices, though digital cameras with high-resolution CCD (charge coupled device) sensors are also being increasingly utilized. Video signals from analog CCTV cameras are converted to a digital format at a central location with an Analog-to-Digital Converter (ADC). The ADC is typically incorporated into a video capture card installed on a personal computer (PC), with the files generated by the video capture card being stored on a hard disk drive on the PC. More particularly, a software module referred to as a codec compresses the raw video data, and appends additional access and integrity data thereto. There is a wide variety of codecs in use, with each emphasizing a different aspect of the video footage such as color depth, motion, and file size. Examples of widely available codecs include those conforming to the MPEG-2 (Motion Pictures Experts Group) standard, the MPEG-4 standard, and the H.264 standard. Upon compressing the video, it may be encapsulated within a container file for subsequent retrieval by the PC. Playback of the surveillance footage is also handled by the PC, which typically includes a media playback software application that implements the decoding functions of the aforementioned codecs.

Instead of relying upon a PC, surveillance systems may incorporate a standalone digital video recorder (DVR). DVRs are similar in functionality to the aforementioned PC-based systems, in that a video capture card retrieves footage from the CCTV camera and converts it for storage on an internal hard disk drive. For purposes of viewing surveillance video, whether it is pre-recorded or live, the DVR may include a user interface through which playback functions such as pause, play speed control, rewind, fast forward, and the like may be controlled. Additionally, the user interface may provide for the adjustment of various camera settings such as brightness, contrast, orientation, and so forth. Though conventional DVR systems generally provide sufficient memory space for short to medium term storage, long term storage of surveillance footage may require archiving to removable media such as DVDs (Digital Versatile Disc) CDs, or tape. Thus, DVRs typically include modalities by which such external data storage devices may be connected thereto.

Due in part to its popularity, DVR surveillance systems are produced by a large number of companies, with each one having a particularized video storage format and a command protocol associated with the playback and camera adjustment controls introduced above. Each DVR may have different advantages and disadvantages that make it suitable for one application or deployment over another, even within the same facility. Alternatively, DVRs of different configurations may be added and removed in piecemeal fashion for cost or other reasons, resulting in a surveillance system of heterogeneous components.

Accordingly, there is a need in the art for integrating the operation of multiple DVRs for access via a unitary interface. More particularly, there is a need for a method of retrieving and displaying surveillance video from DVRs with unique video codecs and interface command protocols. There is also a need for a system capable of backing up the variously encoded surveillance footage for access from such unitary interfaces.

### BRIEF SUMMARY OF THE INVENTION

In accordance with one embodiment of the present invention, a method for processing surveillance video stored on a video storage system may include receiving a universal media control command. The universal media control command may be representative of a video processing instruction and is independent of the video storage system. The method may also include translating the universal media control command to a local control command that is specific to the video storage system. The method may continue with transmitting the local control command to the video storage system. The surveillance video from the video storage system may be retrieved in response to the local control command. The surveillance video may be in a format specific to the video storage system.

According to another embodiment of the present invention, an apparatus for processing surveillance videos from a plurality of video storage systems is contemplated. The apparatus may include a command interface module, which may translate a universal media control command into a first local control command. There may also be a video data interface module, which may decode a first surveillance video stored on a first one of the video storage systems into raw video data. In another embodiment, the video data interface module may acquire a surveillance video stored on the video storage system and encapsulate the same within a universal data file. There may also be a universal recorder module for storing the universal data file for archiving. The present invention will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is an exemplary surveillance configuration including a multiple-codec surveillance video storage and retrieval system in communication with multiple digital video recorders with closed-circuit television cameras feeding surveillance footage thereto;

FIG. 2 is a block diagram of an exemplary digital video recorder including its various internal modules;

FIG. 3 is a block diagram of the surveillance video system including a command interface module, a video data interface module, and a universal recording module;

FIG. 4 is a flowchart illustrating the sequence of steps involved in retrieving surveillance video from a digital video recorder;

FIG. 5 is a flowchart illustrating the steps involved in playing back the surveillance video retrieved from the digital video recorder;

FIG. 6 is a flowchart illustrating the steps involved in archiving surveillance video from the digital video recorder to a universal data file; and

FIG. 7 is a flowchart illustrating the steps involved in playing back the archived surveillance video in the universal data file.

Common reference numerals are used throughout the drawings and the detailed description to indicate the same elements.

### DETAILED DESCRIPTION OF THE INVENTION

The detailed description set forth below in connection with the appended drawings is intended as a description of the presently preferred embodiment of the invention, and is not intended to represent the only form in which the present invention may be developed or utilized. The description sets forth the functions of the invention in connection with the illustrated embodiment. It is to be understood, however, that the same or equivalent functions and may be accomplished by different embodiments that are also intended to be encompassed within the scope of the invention. It is further understood that the use of relational terms such as first and second and the like are used solely to distinguish one from another entity without necessarily requiring or implying any actual such relationship or order between such entities.

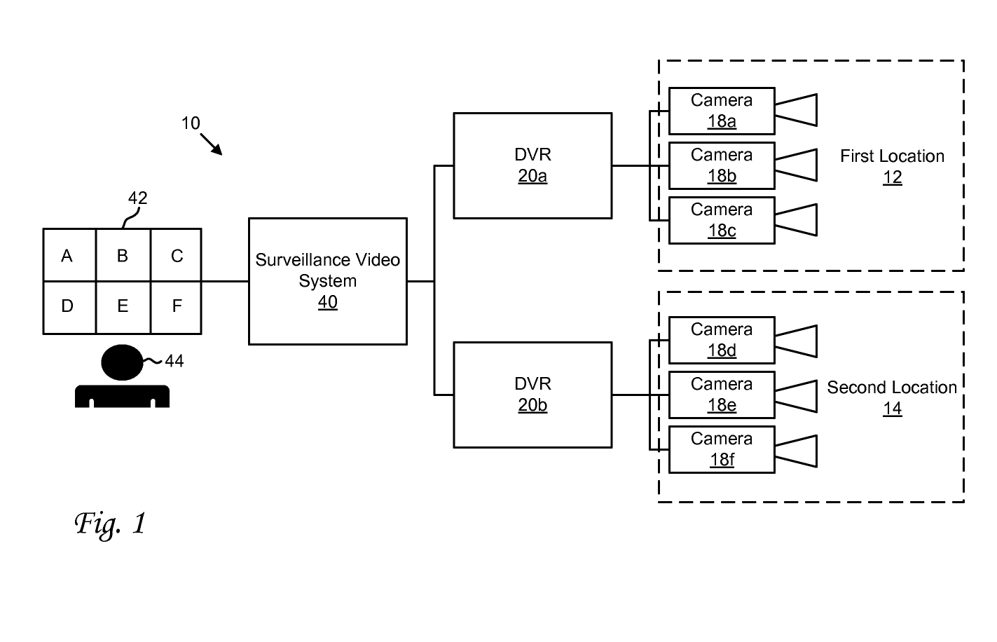

As shown in the block diagram of FIG. 1, an exemplary surveillance configuration 10 is set up to monitor a first location 12 and a second location 14 with variously positioned and arranged cameras 18. The first location 12 has cameras 18a-18c and the second location 14 has cameras 18d-18f. The cameras 18a-c, which monitor the first location 12, are coupled to a first digital video recorder (DVR) 20a, while the cameras 18d-f are coupled to a second DVR 20b.

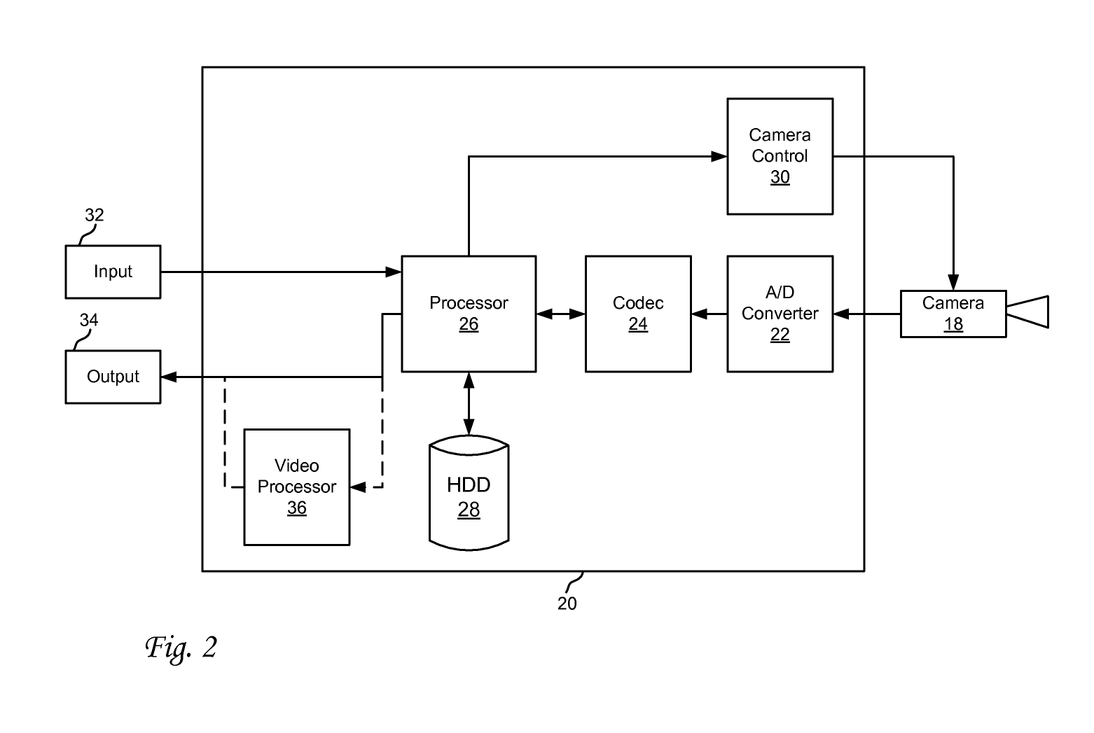

With reference to FIG. 2, further details of the operational features of the DVR 20 and the camera 18 will be considered. The camera 18 are understood to be analog Closed Circuit Television (CCTV) cameras, though digital CCTV cameras that transmit captured video footage in digital form may be readily substituted without departing from the scope of the present invention. Where the camera 18 transmits analog video signals to the DVR 20, an on-board analog to digital converter 22 may digitize such signals. Furthermore, the digitized video signals may be compressed or encoded by a codec 24. As will be recognized by one of ordinary skill in the art, there are a variety of codecs such as MPEG-2, MPEG-4, and H.263. Both the A/D converter 22 and the codec 24 may be under the control of a processor 26, and prior to storing the compressed video data to a long-term data storage device or hard disk drive 28, additional indexing and other processing may be performed thereby. In addition to the hard disk drive 28, the compressed video data may be stored on optical media such as Compact Discs (CDs) and Digital Versatile Discs (DVDs), as well as magnetic tape media. Control of the camera 18 may be specified by instructions from a camera controller 30, and may also be directed by the processor 26.

In order to access the compressed video data from the hard disk drive 28, the DVR 20 may receive instructions conforming to a control command protocol from an input modality 32. Devices such as keyboards, mice, remote controls, or the like may be utilized for manual input of commands by a user. Alternatively, other devices may issue commands to the DVR 20 in a predetermined sequence for automated operation. The control commands may be directed to access control such as locating video footage from a particular date and time or from a particular one of the cameras 18, or to playback controls such as play, pause, stop, fast forward, rewind, and the like. Advanced controls such as zooming and application of image enhancements may also be included. Archival controls for backing up and replaying surveillance video are also contemplated. As referenced herein, the term control commands may refer to any of the foregoing types of controls that modify the functioning of the DVR 20, and it will be appreciated by one of ordinary skill in the art that the foregoing recitation is not exhaustive and by way of example only. Thus, any other suitable commands may be included without departing from the scope of the present invention. Upon receiving the control commands, the processor 26 may locate the particular segment of interest, decode the same with the codec 24, and transmit it to an output device 34. The output device 34 may include digital video display monitors that are capable of receiving video in digitized form. Optionally, a video processor 36 may convert the digital video to an analog signal that may be displayed by an analog video display monitor. The processor 26 may also provide a graphical user interface for interactively controlling the various playback and video retrieval functions.

It will be appreciated that the basics of the surveillance configuration 10 described above, including the description of the camera 18 and the DVR 20, are presented by way of example only and not of limitation. There are numerous ways in which the DVRs 20a-b may be configured internally, and need not include each of the above components. Further, though the exemplary surveillance configuration 10 is shown as monitoring two locations each with three cameras, it will be appreciated that any number of locations may be monitored by any number of cameras. Only the capacities of the individual DVRs 20a-b are limiting in this respect.

As mentioned above, the surveillance configuration 10 may have been built in a piecemeal fashion for cost, technical or other reasons. In this regard, it is understood that the first DVR 20a may store surveillance video in a different format than the second DVR 20b. As referenced herein, the term surveillance video refers to digitized video data from the DVR 20 that is in an encoding and/or format specific thereto. The first and second DVRs 20a-b may therefore be incompatible with each other, and surveillance video stored on one may not be capable of being played back on another. Along these lines, the control commands utilized for directing playback and other functionality of the DVRs 20 may also be incompatible with respect to each other.

With reference to FIG. 1, the surveillance configuration 10 in accordance with one embodiment of the present invention includes a surveillance video system 40 for processing surveillance videos from a plurality of video storage systems or DVRs 20. More particularly, the surveillance videos may be processed by the surveillance video system 40 for playback on a common display 42, in which footage from each of the disparate locations 12 and 14, and the cameras 18a-f are monitored by security personnel 44. Although the common display 42 shows footage from each of the cameras 18a-f being shown simultaneously, this is by way of example only and not of limitation. Footage from a particular one of the cameras 18a-f may occupy the entire screen, with various inputs to the surveillance video system 40 modifying the active one of the cameras 18.

According to one embodiment of the present invention, the surveillance video system 40 is configured to display the surveillance video directly from the DVRs 20a, b, to store a backup copy of the surveillance video retrieved from the DVRs 20a, b, and to display the backup copy from the surveillance video system 40. Each of these features may be provided via a universal media control command interface, a universal video display format, and a universal data file.

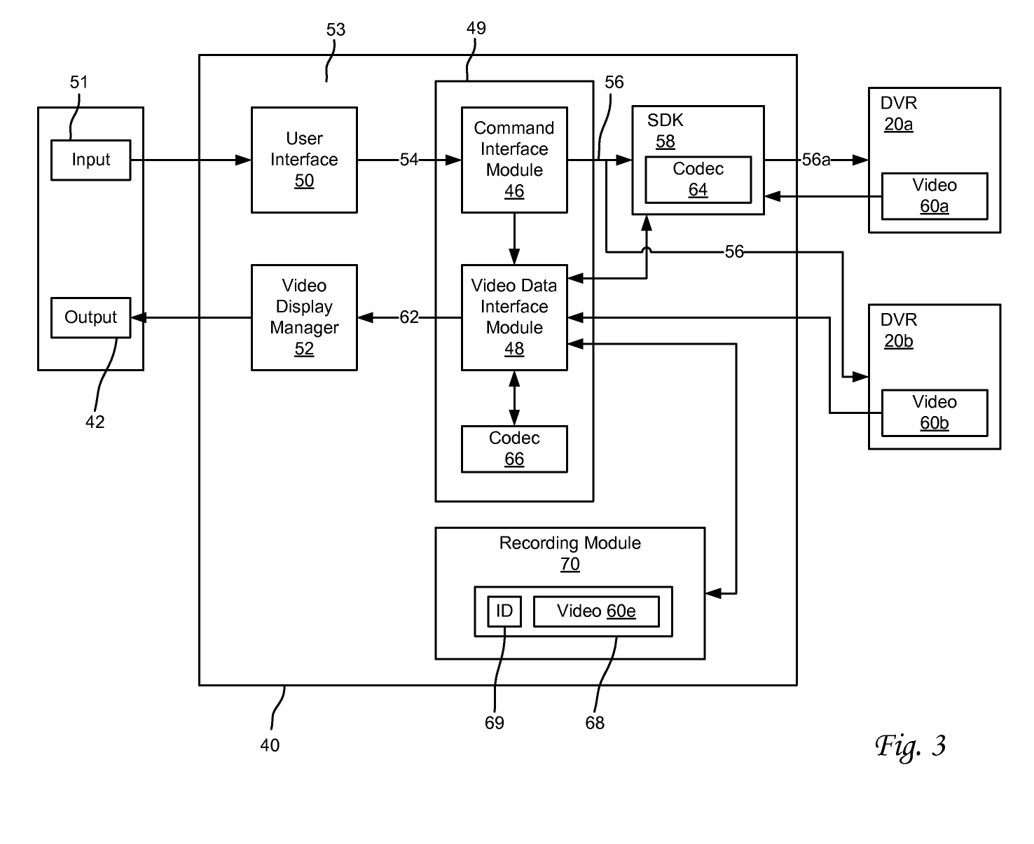

With reference to the block diagram of FIG. 3, the surveillance video system 40 includes a command interface module 46 and a video data interface module 48, which are grouped into a network module 49. As indicated above, the surveillance video system 40 communicates with DVRs having varied control command protocols, while providing a unitary interface to a user or security personnel 44. In further detail, the surveillance video system 40 includes a user interface 50 and a video display manager 52, which are grouped into a main module 53. The user interface 50 generates graphical elements corresponding to the aforementioned control commands such as access and playback control, and the activation thereof is operative to generate a universal media control command 54. The user interface 50 receives input 51 representative of such activation of control commands. It is contemplated that the video display manager 52 outputs the graphical elements generated by the user interface 50, and performs other output functions described in greater detail below. The universal control command 54 from the user interface 50 is relayed to the command interface module 46.

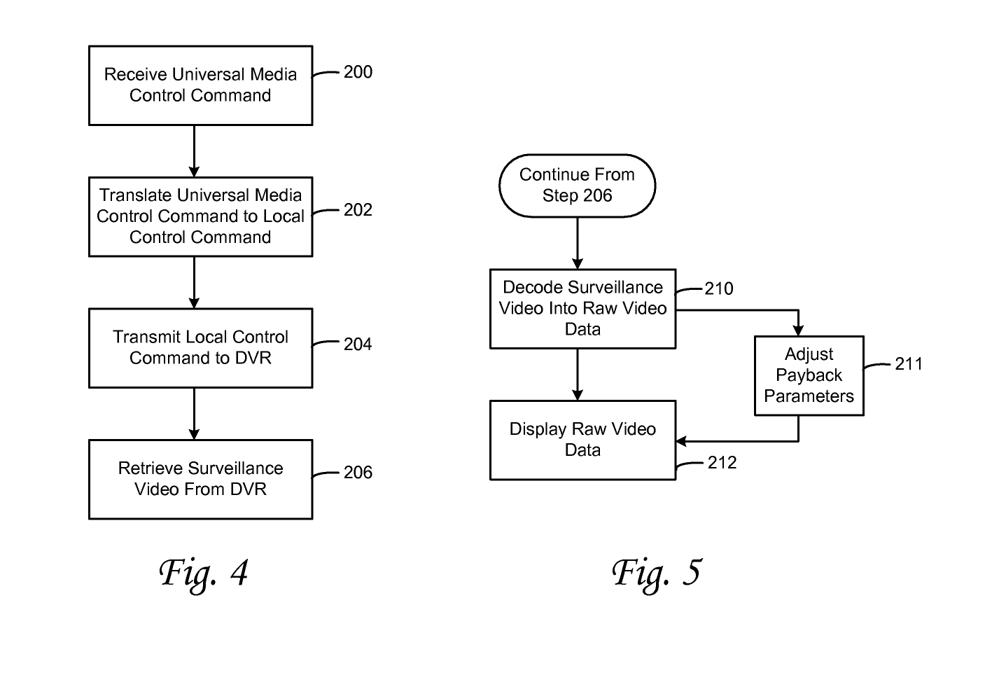

With reference to the flowchart of FIG. 4, the method for processing surveillance video in accordance with one embodiment of the present invention begins with a step 200 of receiving the universal media control command 54. The universal media control command 54 is representative of an instruction for modifying the processing of the surveillance video stored on the DVR 20, such as the above-described access controls, playback controls, advanced controls, and the archival controls. The universal media control command 54 is independent of the specific protocols of the DVR 20, that is, the universal media control command 54 as utilized between the user interface 50 and the command interface module 46 is the same regardless of the control command required to communicate with the first and second DVRs 20a or 20b. The method continues with a step 202 of translating the universal media control command 54 into a local control command 56. This is followed by a step 204 of transmitting the local control command 56 to the DVR 20.

As mentioned above, the control commands and the storage format in which the surveillance video is stored differ from one DVR to another. In order to provide limited compatibility, DVRs may be provided with a software development kit (SDK), also referred to herein as a plugin module. SDKs generally include an application programming interface which allows external software applications access to libraries and functions internal to the DVR software. By way of example only and not of limitation, the first DVR 20a is provided with a particularly corresponding SDK 58. It is understood that the functions provided in the SDK 58 are executed internally with respect to the surveillance video system 40. Where the command interface module 46 is directing the functionality of the first DVR 20a, the local control command 56 is issued to the SDK 58. The SDK 58 then issues a secondary local control command 56a to the DVR 20a. It will be appreciated that the details of the protocol to which the secondary local control command 56a conforms is abstracted out from the command interface module 46, so the local control command 56 may not necessarily conform to the protocol of the first DVR 20a. Alternatively, where an SDK is not provided as in the case with the second DVR 20b, the local control command 56 is directly transmitted thereto. In this regard, the local control command 56 conforms to the protocol of the second DVR 20b. These features are understood to relate to the aforementioned universal media control command interface.

Referring again to the flowchart of FIG. 4 and the block diagram of FIG. 3, the method according to one embodiment of the present invention continues with a step 206 of retrieving the surveillance video from the DVR 20 in response to the local control command 56. In this regard, the local control command 56 and the corresponding universal media control command 54 are generally directed to requesting the surveillance video from the DVR 20. It is understood that the surveillance video is in a format specific to the DVR 20 on which it is stored. Thus, the first DVR 20a has a surveillance video 60a that is stored in a format specific thereto, and the second DVR 20b has stored thereon a second surveillance video 60b in a format specific thereto. When referring to the surveillance video 60 being in a specific format, it is understood that this refers to the particular encoding format, as well as any other particularized arrangement of the data of the surveillance video 60.

As shown in the flowchart of FIG. 5 and the block diagram of FIG. 3, the method of one embodiment of the present invention continues with a step 210 of decoding the surveillance video 60 into raw video data 62. Because the SDK 58 handles all processing and transactions between the surveillance video system 40 and the DVR 20a, the corresponding surveillance video 60a is likewise received thereby. More particularly, the SDK 58 includes a plugin codec 64 that decodes the surveillance video 60a into the raw video data 62. It is understood that the plugin codec 64 corresponds to the specific format of the first DVR 20a. The SDK 58 passes the raw video data 62 to the video data interface module 48. On the other hand, where there is no SDK provided as in the second DVR 20b, decoding of the second surveillance video 60b is performed by an internal codec 66. Specifically, the video data interface module 48 retrieves the second surveillance video 60b and calls the internal codec 66. The internal codec 66 then decodes the second surveillance video 60b to the raw video data 62. As referenced herein, the raw video data 62 refers to video capable of being displayed regardless of it being encoded in a format specific to a DVR 20. In other words, the raw video data 62 is platform-agnostic.

After decoding the surveillance video 60 in step 210, the resultant raw video data 62 is displayed according to a step 212. In accordance with one embodiment of the present invention, the raw video data 62 is displayed on the common display 42. Further, it is expressly contemplated that the raw video data 62 corresponding to the first surveillance video 60a and to the second surveillance video 60b can be simultaneously displayed/played back on the common display 42. Optionally, as per step 211, the raw video data 62 may be repositioned or modified to fit within the constraints of the display 42. More particularly, the size of each frame of the raw video data 62 and the resolution may be modified, and supplemental text information may be added. The playback parameters of the raw video data 62 may be adjusted to a predetermined value. The foregoing features concerning the decoding and display of the surveillance video 60 generally relate to the aforementioned universal video display format.

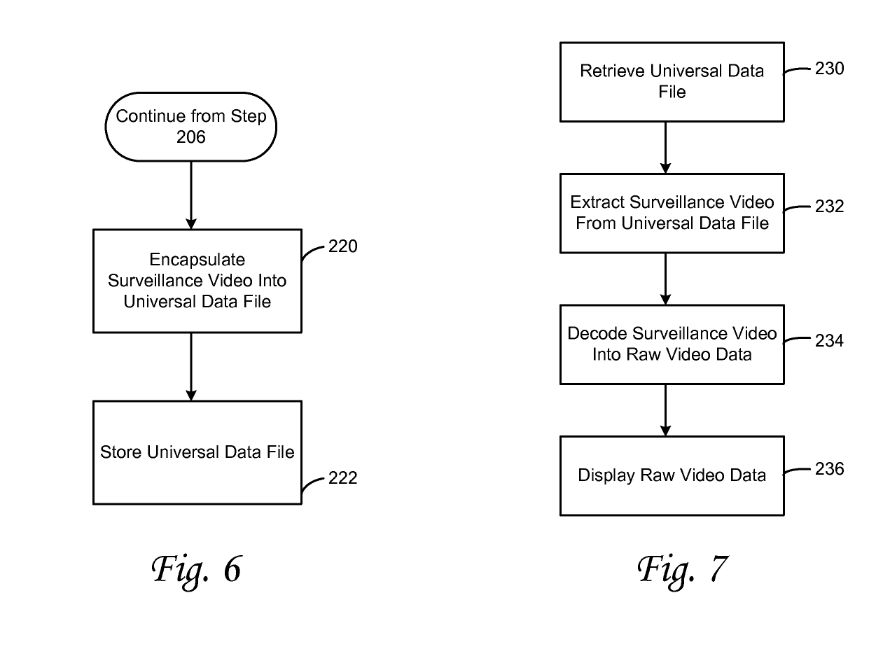

Having considered the features relating to the playback of live or recorded surveillance video from the DVR 20, embodiments of the present invention relating to the backup and subsequent access of surveillance video will now be considered in view of the universal data file. With reference to the flowchart of FIG. 6, the method according to one embodiment includes a step 220 of encapsulating the surveillance video 60 into a universal data file 68. Also encapsulated with the surveillance video 60 is a storage system identifier 69, which defines the particular type of the storage system or DVR 20 from which the surveillance video 60 originates.

The sequence of steps that occur prior to the first DVR 20a or the second DVR 20b transmitting the first and second surveillance videos 60a, 60b, respectively, to the video data interface module 48 is similar to that of retrieving the surveillance video 60 for direct playback purposes as detailed above. The universal media control command 54 is directed to initiating archiving functions, and is translated into the local control command 56 by the command interface module 46. A common user interface 50 provides a consistent modality to access the archiving functionality despite differing local control commands 56 that must be issued to different DVRs 20. Additional operating parameters in the universal media control command 54 may include, for example, the time range in the surveillance video 60 to archive.

Unlike the retrieval of the surveillance video 60 for direct playback on the surveillance video system 40, however, the archiving process does not necessitate decoding the surveillance video 60 prior to encapsulation within the universal data file 68. With receipt of the local control command 56, which is directed to initiating archiving functions as indicated above, the first DVR 20a transmits the first surveillance video 60a to the SDK 58. The SDK 58, in turn, transmits the surveillance video 60a to the video data interface module 48 without decoding, where it is encapsulated into the universal data file 68. When the second DVR 20b receives the local control command 56, the second DVR 20b transmits the second surveillance video 60b to the video data interface module, also without decoding. After encapsulating the surveillance video 60 and the storage system identifier 69 within the universal data file 68 as described above, the video data interface module 48 transmits the constructed universal data file 68 to a universal recording module 70. A new instance of the universal data file 68 may be generated for each discrete one of the surveillance video 60 specified for archival. In accordance with one embodiment of the present invention, the universal data file 68 is stored per step 222 with appropriate indexing. The universal recording module 70 may be connected a hard disk drive or other like data storage device, and may have a particularized file system different from that of the DVR 20. Since the original surveillance video 60 is retained throughout archival, advantages associated with particular formats are retained, and surveillance from a wide variety of DVRs 20 may be simultaneously stored and accessible from a single point. The universal data file 68 may be replicated to removable media such as CDs and DVDs, without the necessity of independently tracking the particular DVR in which the corresponding surveillance video originated.

With reference to the flowchart of FIG. 7, playing back the contents of the universal data file 68 may initiate with a step 230 of retrieving the universal data file 68 from the universal recorder module 70. This retrieval step may be initiated by a universal media control command 54 being received by the user interface 50, and it contains instructions to this effect. Additional parameters such as the particular one of the universal data file 68 may also be specified. The command interface module 46, upon receipt of the universal media control command 54, may transmit an instruction directly to the video data interface module 48 to retrieve a particular universal data file 68. The video data interface module 48 accesses the specified universal data file 68, and according to a step 232, extracts the surveillance video 60e and the storage system identifier 69 therefrom. In this regard, it is contemplated that the universal data 68 be structured and formatted to be parsed by the video data interface module 48.

Thereafter, per step 234, the extracted surveillance video 60e is decoded into the raw video data 62 as described above. Specifically, where the extracted surveillance video 60e has a corresponding SDK 58, as was the case with the first surveillance video 60a, the video data interface module 48 calls the plugin codec 64. The plugin codec 64 is understood to decode the extracted surveillance video 60e and transmit the resulting raw video data 62 to the video display manager 52, where minor adjustments may be made. According to a step 236, the raw video data 62 may then be displayed, or output to the common display 42. Where the extracted surveillance video 60e originates from a DVR without an SDK, the internal codec 66 is called, which decodes to the raw video data 62. Again, the raw video data 62 may be adjusted as described above, and output to the common display 42 per step 236.

As indicated above, one embodiment contemplates the selection of the particular codec to decode the extracted surveillance video 60e to be determined by the storage system identifier 69. Alternatively, the video data interface module 48 may determine the proper codec based upon the characteristics of the extracted surveillance video 60e without further consideration of other data contained in the universal data file 68. It will be appreciated by one of ordinary skill in the art that any other well-known codec/format identification techniques may be readily substituted without departing from the scope of the present invention.

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

What is claimed is:

1. A method for processing surveillance video stored on a video storage system, the method comprising the steps of:
receiving a universal media control command, the universal media control command being representative of a video processing instruction and independent of the video storage system;
translating the universal media control command to a local control command specific to the video storage system;
transmitting the local control command to the video storage system; and
retrieving the surveillance video from the video storage system in response to the local control command, the surveillance video being in a format specific to the video storage system.

2. The method of claim 1, further comprising the steps of:
decoding the surveillance video into raw video data, the raw video data being in a format independent of the video storage system; and
displaying the raw video data.

3. The method of claim 1, further comprising the steps of:
encapsulating the surveillance video and a storage system identifier into a universal data file; and
storing the universal data file on a universal surveillance storage unit for subsequent processing.

4. The method of claim 3, further comprising the steps of:
retrieving the universal data file;
extracting the surveillance video and the storage system identifier from the universal data file;
decoding the surveillance video into raw video data based upon the storage system identifier, the raw video data being in a format independent of the video storage system; and
displaying the raw video data.

5. The method of claim 4, further comprising the step of adjusting playback parameters of the raw video data to a predetermined value.

6. The method of claim 4, wherein the surveillance video is decoded into the raw video data by a codec incorporated into the universal surveillance storage unit.

7. The method of claim 1, wherein the video storage system is a digital video recorder coupled to a surveillance camera, footage from the surveillance camera being stored on the digital video recorder as the surveillance video.

8. An apparatus for processing surveillance videos from a plurality of video storage systems, the apparatus comprising:
a command interface module for translating a universal media control command into a first local control command; and
a video data interface module for decoding a first surveillance video stored on a first one of the video storage systems into raw video data, the first surveillance video being acquired in response to receipt of the first local control command by the first one of the video storage systems.

9. The apparatus of claim 8, wherein the video data interface cooperates with a plug-in module to decode the first surveillance video, the external plug-in module including a decoder corresponding to a format of the first storage system.

10. The apparatus of claim 8, further comprising:
an internal decoder in communication with the video data interface to decode the first surveillance video, the internal decoder corresponding to a format of the first storage system.

11. The apparatus of claim 8, further comprising:
a video monitor;
a user interface module for relaying a universal media control command to the command interface module; and
a video display manager for displaying on the video monitor the raw video data from the video data interface module.

12. The apparatus of claim 8, wherein:
the command interface module translates the universal media control command into a second local control command;
the video data interface module decodes a second surveillance video stored on a second one of the video storage systems into raw video data, the second surveillance video being acquired in response to receipt of the second local control command by the second one of the video storage systems; and
the first surveillance video is stored in a format different from the second surveillance video.

13. The apparatus of claim 12, wherein the raw video data of the first surveillance video and the raw video data of the second surveillance video are simultaneously displayed.

14. The apparatus of claim 8, wherein the video storage system is a digital video recorder coupled to a surveillance camera, footage from the surveillance camera being stored on the digital video recorder as the surveillance video.

15. An apparatus for processing surveillance video stored on a video storage system, the apparatus comprising:
a command interface module for translating a universal media control command into a local control command;
a video data interface module for acquiring a surveillance video on the video storage system and encapsulating the surveillance video within a universal data file, the surveillance video being acquired in response to receipt of the local control command thereby; and
a universal recorder module for storing the universal data file.

16. The apparatus of claim 15, wherein the video data interface module extracts the surveillance video contained in the universal data file.

17. The apparatus of claim 16, wherein the video data interface cooperates with an external plug-in module to decode the surveillance video, the external plug-in module including a decoder corresponding to the storage system identifier in the universal data file.

18. The apparatus of claim 16, wherein the video data interface further includes a decoder corresponding to the storage system identifier in the universal data file.

19. The apparatus of claim 16, further comprising:
a video monitor; and
a video display manager for displaying on the video monitor raw video data decoded from the surveillance video.

20. The apparatus of claim 15, wherein the video storage system is a digital video recorder coupled to a surveillance camera, footage from the surveillance camera being stored on the digital video recorder as the surveillance video.
